(19) United States
(12) Patent Application Publication
(10) Pub. No.: US 2025/0392195 A1
(43) Pub. Date: Dec. 25, 2025

(54) SYSTEM AND METHOD FOR COOLING CARBON BRUSHES AND SLIP RINGS

(71) Applicant: Dana Automotive Systems Group, LLC, Maumee, OH (US)

(72) Inventors: Maarten DEBROUWERE, Zedelgem (BE); Frederik DESMET, Maldegem (BE); Steven VANHEE, Hooglede (BE)

(21) Appl. No.: 18/748,556

(22) Filed: Jun. 20, 2024

(51) Int. Cl. H02K 9/28; H02K 7/00; H02K 13/00

(52) U.S. Cl. CPC H02K 9/28; H02K 13/003; H02K 7/003

(57) ABSTRACT

Methods and systems for cooling brushes of an electric machine are described. The system may include a slip ring module that includes two slip rings that transfer power between a stationary power source and rotating windings of the electric machine. The slip ring module includes bore holes that operate as coolant passages for coolant that flows to the two slip rings.

### TECHNICAL FIELD

The present disclosure relates to cooling of carbon brushes and slip rings of an electric machine.

### BACKGROUND AND SUMMARY

Permanent magnet alternating current (AC) electric machines utilize permanent magnets that are placed in the electric machine’s rotor and AC power is applied to the electric machine’s stator windings to operate. So called “rare-earth” magnets may be incorporated into a permanent magnet alternating current electric machine to increase the electric machine’s performance and efficiency. However, these magnets increase the financial expense of the electric machine and they may also have other issues. Therefore, it may be desirable to produce an electric machine that operates similarly to a permanent magnet alternating current electric machine, but without permanent magnets.

The inventors have recognized the aforementioned challenges and developed an electric machine, comprising: a rotor including a first slip ring and a second slip ring, the rotor including a shaft; one or more coolant passages arranged to supply coolant to cool the first slip ring and the second slip ring; a first brush in contact with the first slip ring and a second brush in contact with the second slip ring; and a stator.

By providing coolant passages that direct coolant flow to slip rings of an electric machine, it may be possible to provide the technical result of generating a strong magnetic field within rotor windings while reducing a possibility of brush and slip ring degradation. In particular, coolant flowing in contact with slip rings may cool the slip rings and brushes that are in contact with the slip rings so that the slip rings and brushes remain within a desired temperature range during electric machine operation. Further, the flow of coolant past the slip rings may be uniform so that a possibility of localized heating may be reduced.

The electric machine and slip ring module that is described herein may provide several advantages. Specifically, the slip ring and carbon brush cooling module provides direct cooling (e.g., coolant directly contacts the slip rings) of slip rings and indirect cooling of carbon brushes that contact the slip rings to reduce a possibility of slip ring and brush degradation. Further, the approach allows the brushes to remain dry while the slip rings and brushes are being cooled so that the cooling system may remain isolated from the brushes. Further still, the approach allows for a strong magnetic field to be generated via the rotor so that use of permanent magnets may be avoided.

It may be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a plan view of an example vehicle that includes an electric machine with liquid cooled slip rings.

FIG. 2 shows a cut-away view of an example electric machine.

FIG. 3 shows a sectional view of a slip ring module.

FIG. 4 shows a cross-section of a first example slip ring module.

FIG. 5 shows a cross-section of a second example slip ring module.

FIG. 6 shows an example method for constructing a slip ring module and cooling slip rings of an electric machine.

### DETAILED DESCRIPTION

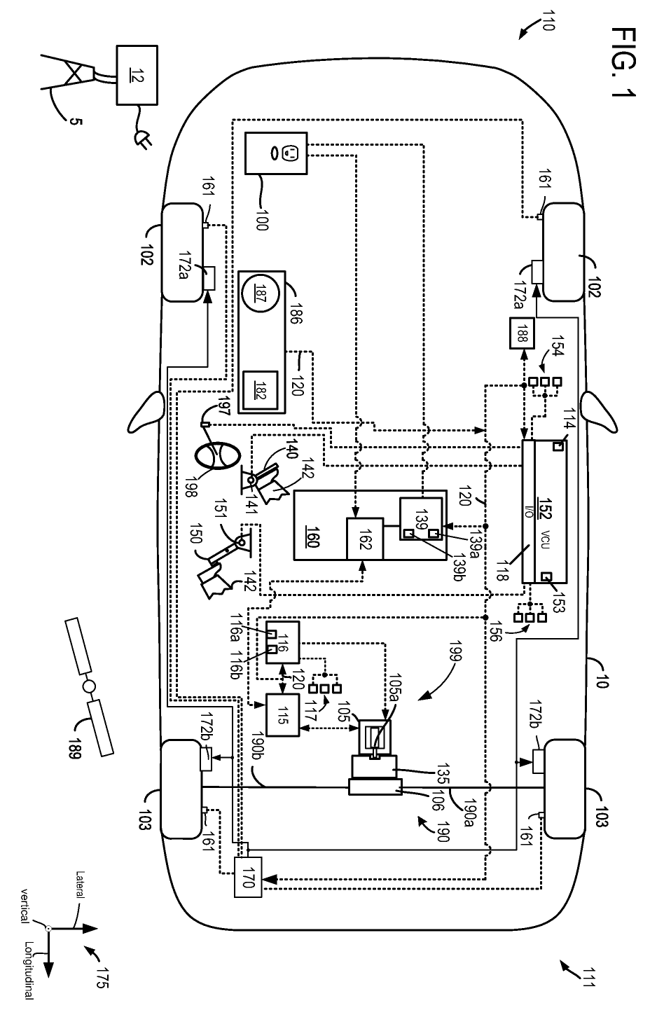

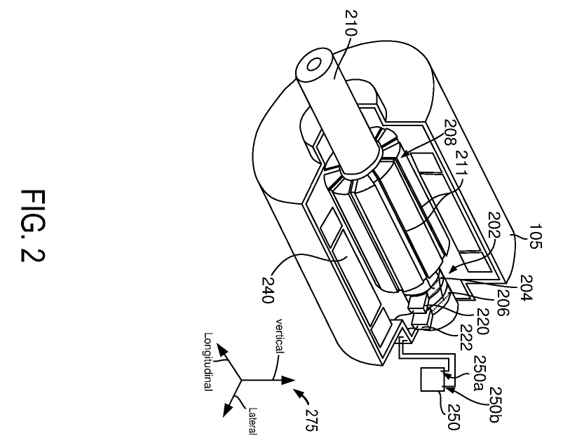

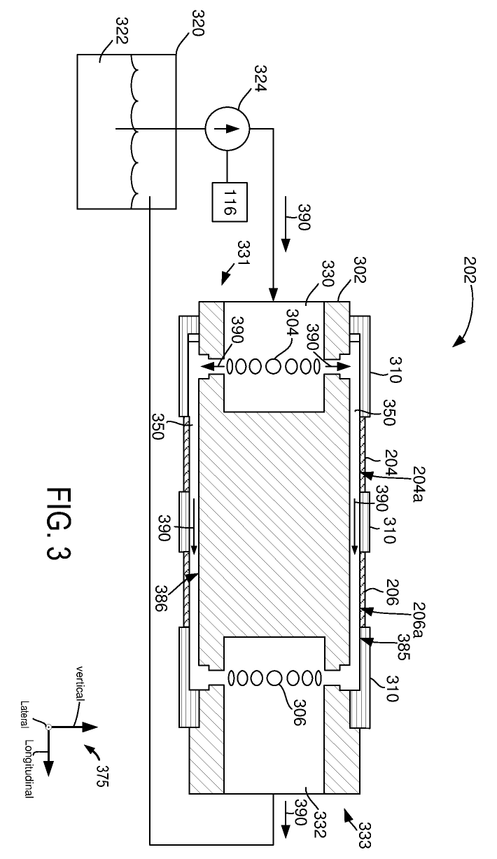

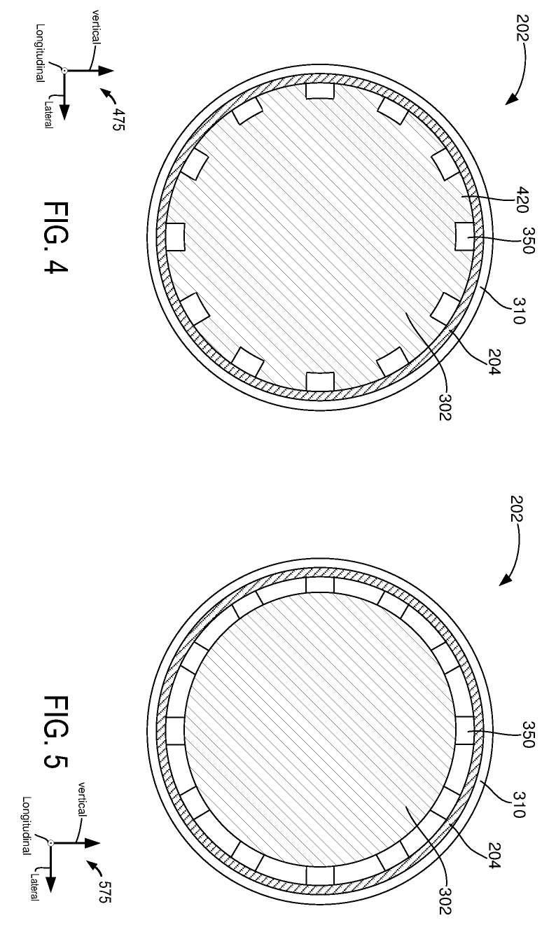

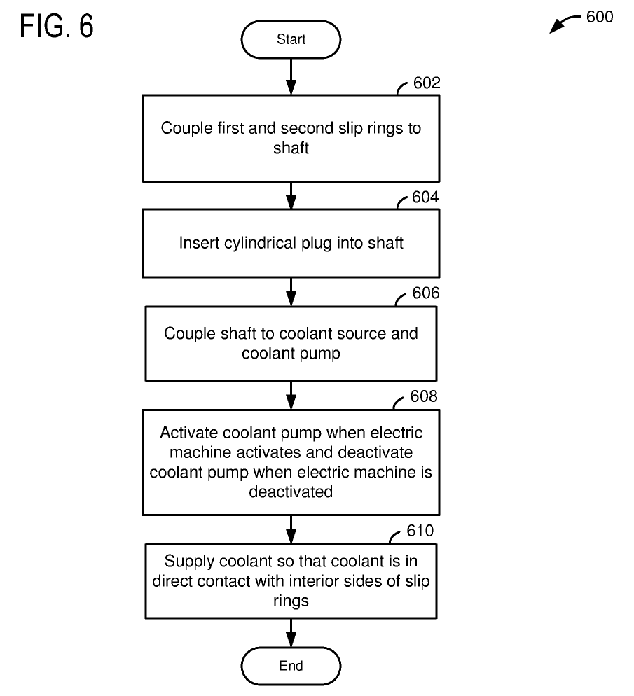

A slip ring module with coolant passages is described. The slip ring module may be coupled to a liquid coolant system that supplies a liquid coolant (e.g., oil) that comes into direct contact with slip rings of the slip ring module. The slip ring module may interface with rotor windings and carbon brushes to transfer electric power between the carbon brushes and the rotor windings. In one example, the electric machine may be a traction motor for a vehicle as shown in FIG. 1. The traction motor may be of the form that is shown in FIG. 2. In one example, the slip ring module may be constructed as shown in FIG. 3. FIGS. 4 and 5 show cross sections of two different embodiments of the slip ring module. Finally, FIG. 6 shows a method of constructing and applying a slip ring module.

FIGS. 1-5 are drawn approximately to scale. However, the slip ring module and electric machine that are described herein may have other relative component dimensions in alternate embodiments.

FIG. 1 illustrates an example vehicle propulsion system 199 for vehicle 10. In FIG. 1 mechanical connections between the various components are illustrated as solid lines, whereas electrical connections between various components are illustrated as dashed lines. Vehicle front end is indicated at 110 and vehicle rear end is indicated at 111. Vehicle 10 travels in a forward direction when vehicle front end 110 leads movement of vehicle 10. Vehicle 10 travels in a reverse direction when vehicle rear end 111 leads movement of vehicle 10. In this example, vehicle 10 is a rear wheel drive vehicle, but in other examples, vehicle 10 may be a four-wheel drive or front wheel drive vehicle.

Vehicle propulsion system 199 includes a propulsion source 105 (e.g., an electric machine, such as a motor), but in other examples two or more propulsion sources may be provided. In one example, propulsion source 105 may be a synchronous electric machine that may operate as a motor or generator. In other examples, propulsion source 105 may be a direct current (DC) machine. Vehicle propulsion system 199 also includes a transmission 135. The propulsion source 105 is fastened to the transmission 135 and propulsion source 105 delivers power from its rotor 105a to transmission 135. Transmission 135 may be mechanically coupled to differential gears. Differential gears 106 may be coupled to two axle shafts, including a first or right axle shaft 190a and a second or left axle shaft 190b. Vehicle 10 further includes front wheels 102 and rear wheels 103.

The transmission 135 may be referred to as a step ratio transmission, or alternatively, a different configuration. Transmission 135 may include one or more clutch actuators (not shown) to shift one or more clutches. In this example, electric power inverter 115 is electrically coupled to propulsion source 105 to convert DC power to alternating current (AC) and vise-versa. Powertrain controller 116 is electrically coupled to sensors 117 and actuators of vehicle propulsion system 199. For example, sensors 117 may include, but are not limited to inverter switch temperature sensors, electric machine winding temperature sensors, bus bar temperature sensors, etc.

Transmission 135 may transfer mechanical power to or receive mechanical power from differential gears 106. Differential gears 106 may transfer mechanical power to or receive mechanical power from rear wheels 103 via right axle shaft 190a and left axle shaft 190b. Propulsion source 105 may consume alternating current (AC) electrical power provided via electric power inverter 115. Alternatively, propulsion source 105 may provide AC electrical power to electric power inverter 115. Electric power inverter 115 may be provided with high voltage direct current (DC) power from battery 160 (e.g., a traction battery, which also may be referred to as an electric energy storage device or battery pack). Electric power inverter 115 may convert the DC electrical power from battery 160 into AC electrical power for propulsion source 105. Alternatively, electric power inverter 115 may be provided with AC power from propulsion source 105. Electric power inverter 115 may convert the AC electrical power from propulsion source 105 into DC power to store in battery 160.

Propulsion source 105 may transfer mechanical power to or receive mechanical power from transmission 135. As such, transmission 135 may be a multi-speed gear set that may shift between gear ratios when commanded via powertrain controller 116. Powertrain controller 116 includes a processor 116a and memory 116b. Memory 116b (e.g., storage media) may include read exclusive memory, random access memory, and keep alive memory. The memory may be programmed with computer readable data representing instructions that are executable by a processor for performing the methods and control techniques described herein as well as other variants that are anticipated but not specifically listed. As such, control techniques, methods, and the like expanded upon herein may be stored as instructions in non-transitory memory.

Battery 160 may periodically receive electrical energy from a power source such as a stationary power grid 5 residing external to the vehicle (e.g., not part of the vehicle). As a non-restricted example, vehicle propulsion system 199 may be configured as a plug-in electric vehicle (EV), whereby electrical energy may be supplied to battery 160 via the stationary power grid 5 and charging station 12. Electric charge may be delivered to battery 160 via plug receptacle 100.

Battery 160 may include a BMS controller 139 (e.g., a battery management system controller) and an electrical power distribution box 162. BMS controller 139 may provide charge balancing between energy storage elements (e.g., battery cells) and communication with other vehicle controllers (e.g., vehicle control unit 152). BMS controller 139 includes a core processor 139a and memory 139b (e.g., random-access memory, read-exclusive memory, and keep-alive memory).

Vehicle 10 may include a vehicle control unit (VCU) 152 that may communicate with electric power inverter 115, powertrain controller 116, friction or foundation caliper controller 170, global positioning system (GPS) 188, BMS controller 139, and dashboard 186 and components included therein via controller area network (CAN) 120. VCU 152 includes memory 114, which may include read-exclusive memory (ROM or non-transitory memory) and random access memory (RAM). VCU also includes a digital processor or central processing unit (CPU) 153, and inputs and outputs (I/O) 118 (e.g., digital inputs including counters, timers, and discrete inputs, digital outputs, analog inputs, and analog outputs). VCU may receive signals from sensors 154 and provide control signal outputs to actuators 156. Sensors 154 may include but are not restricted to lateral accelerometers, longitudinal accelerometers, yaw rate sensors, inclinometers, temperature sensors, battery voltage and current sensors, and other sensors described herein. Additionally, sensors 154 may include steering angle sensor 197, driver demand pedal position sensor 141, vehicle range finding sensors including radio detection and ranging (RADAR), light detection and ranging (LIDAR), sound navigation and ranging (SONAR), and caliper application pedal position sensor 151. Actuators may include but are not constrained to inverters, transmission controllers, display devices, human/machine interfaces, friction caliper systems, and battery controller described herein.

Driver demand pedal position sensor 141 is shown coupled to driver demand pedal 140 for determining a degree of application of driver demand pedal 140 by human 142. Caliper application pedal position sensor 151 is shown coupled to caliper application pedal 150 for determining a degree of application of caliper application pedal 150 by human 142. Steering angle sensor 197 is configured to determine a steering angle according to a position of steering wheel 198.

Vehicle propulsion system 199 is shown with a global position determining system 188 that receives timing and position data from one or more GPS satellites 189. Global positioning system may also include geographical maps that are stored in ROM for determining the position of vehicle 10 and features of roads that vehicle 10 may travel on.

Vehicle propulsion system 199 may also include a dashboard 186 that an operator of the vehicle may interact with. Dashboard 186 may include a display system 187 configured to display information to the vehicle operator. Display system 187 may comprise, as a non-restricting example, a touchscreen, or human machine interface (HMI), display which enables the vehicle operator to view graphical information as well as input commands. In some examples, display system 187 may be connected wirelessly to the internet (not shown) via VCU 152. As such, in some examples, the vehicle operator may communicate via display system 187 with an internet site or software application (app) and VCU 152.

Dashboard 186 may further include an operator interface 182 via which the vehicle operator may adjust the operating status of the vehicle. Specifically, the operator interface 182 may be configured to activate and/or deactivate operation of the vehicle driveline (e.g., propulsion source 105) based on an operator input. Further, an operator may request an axle mode (e.g., park, reverse, neutral, drive) via the operator interface. Various examples of the operator interface 182 may include interfaces that utilize a physical apparatus, such as a key, that may be inserted into the operator interface 182 to activate the vehicle propulsion system 199 including propulsion source 105 and to turn on the vehicle 10. The apparatus may be removed to shut down the transmission 135 and propulsion source 105 to turn off vehicle 10. Propulsion source 105 may be activated via supplying electric power to propulsion source 105 and/or electric power inverter 115. Propulsion source 105 may be deactivated by ceasing to supply electric power to propulsion source 105 and/or electric power inverter 115. Still other examples may additionally or optionally use a start/stop button that is manually pressed by the operator to start or shut down the propulsion source 105 to turn the vehicle on or off. In other examples, a remote electrified axle or electric machine start may be initiated remote computing device (not shown), for example a cellular telephone, or smartphone-based system where a user’s cellular telephone sends data to a server and the server communicates with the vehicle control unit 152 to activate the inverter 115 and propulsion source 105. Spatial orientation of vehicle 10 is indicated via axes 175.

Vehicle 10 is also shown with a foundation or friction caliper controller 170. Friction caliper controller 170 may selectively apply and release friction calibers (e.g., 172a and 172b) via allowing hydraulic fluid to flow to the friction calipers. The friction calipers may be applied and released so as to reduce locking of the friction calipers to front wheels 102 and rear wheels 103. Wheel position or speed sensors 161 may provide wheel speed data to friction caliper controller 170. Vehicle propulsion system 199 may provide torque to rear wheels 103 to propel vehicle 10.

A human or autonomous driver 142 may request a driver demand wheel torque, or alternatively a driver demand wheel power, via applying driver demand pedal 140 or via supplying a driver demand wheel torque/power request to vehicle control unit 152. Vehicle control unit 152 may then demand a torque or power from propulsion source 105 via commanding powertrain controller 116. Powertrain controller 116 may command electric power inverter 115 to deliver the driver demand wheel torque/power via electrified axle 190 and propulsion source 105. Electric power inverter 115 may convert DC electrical power from battery 160 into AC power and supply the AC power to propulsion source 105. Propulsion source 105 rotates and transfers torque/power to transmission 135. Transmission 135 may supply torque from propulsion source 105 to differential gears 106, and differential gears 106 transfer torque from propulsion source 105 to rear wheels 103 via axle shafts 190a and 190b.

During conditions when the driver demand pedal is fully released, vehicle control unit 152 may request a small negative or regenerative power to gradually slow vehicle 10 when a speed of vehicle 10 is greater than a threshold speed. The amount of regenerative power requested may be a function of driver demand pedal position, battery state of charge (SOC), vehicle speed, and other conditions. If the driver demand pedal 140 is fully released and vehicle speed is less than a threshold speed, vehicle control unit 152 may request a small amount of positive torque/power (e.g., propulsion torque) from propulsion source 105, which may be referred to as creep torque or power. The creep torque or power may allow vehicle 10 to remain stationary when vehicle 10 is on a small positive grade.

The human or autonomous driver may also request a negative or regenerative driver demand slowing torque, or alternatively a driver demand slowing power, via applying caliper pedal 150 or via supplying a driver demand slowing power request to vehicle control unit 152. Vehicle control unit 152 may request that a first portion of the driver demanded slowing power be generated via propulsion source 105 via commanding powertrain controller 116. Additionally, vehicle control unit 152 may request that a portion of the driver demanded slowing power be provided via friction calipers 172a and 172b via commanding friction caliper controller 170 to provide a second portion of the driver requested slowing power.

After vehicle control unit 152 determines the slowing power request, vehicle control unit 152 may command powertrain controller 116 to deliver the portion of the driver demand slowing power allocated to propulsion source 105. Propulsion source 105 may convert the vehicle’s kinetic energy into AC power.

Powertrain controller 116 includes predetermined transmission gear shift schedules whereby fixed ratio gears of transmission 135 may be selectively engaged and disengaged. Shift schedules stored in powertrain controller 116 may select gear shift points or events as a function of driver demand wheel torque and vehicle speed.

Referring now to FIG. 2, a cut-away view of propulsion source 105 is shown. In this example, slip ring module 202 is shown fastened to shaft 210 of rotor 208. Slip ring module 202 rotates with shaft 210. In some examples, slip ring module 202 may be an integral part of rotor 208 (e.g., fabricated as part of rotor 208), while in other examples, slip ring module 202 may be fixed or fastened to rotor 208. In addition to shaft 210, rotor 208 includes windings 211 that rotate with rotor 208. Windings 211 are electrically coupled to first slip ring 204 and second slip ring 206 of slip ring module 202. Rotor 208 may rotate within stator 240.

A first terminal 250a (e.g., a positive terminal) of DC power source 250 is electrically coupled to first carbon brush 220 and a second terminal 250b (e.g.,. a negative terminal) of DC power source 250 is electrically coupled to second carbon brush 222. First carbon brush 220 may transfer electric power from DC power source 250 to first slip ring 204. Second carbon brush 222 may be a return path back to DC power source 250 from windings 211 so that windings 211 may generate a magnetic field. Coolant comes into direct contact with the first slip ring interior side 204a and second slip ring interior side 206a. Vertical, longitudinal, and lateral directions with respect to propulsion source 105 are shown at axes 275.

Turning now to FIG. 3, a detailed section of slip ring module 202 is shown. In this example, slip ring module 202 is shown as a separate and distinct assembly apart from the shaft of the propulsion source, but it may be part of the propulsion source shaft in some examples. Vertical, longitudinal, and lateral directions with respect to propulsion source 105 are shown at axes 375.

Slip ring module 202 includes a shaft portion 310, shaft portion 310 may be part of rotor shaft 210 shown in FIG. 2, or if slip ring module 202 is fastened to shaft 210, it may be distinct from rotor shaft 210. A first slip ring 204 is fixed to shaft portion 310 and it is electrically insulated from shaft portion 310 via an electrical insulator (not shown). Likewise, second slip ring 206 is fixed to shaft portion 310 and it is electrically insulated from shaft portion 310 via an electrical insulator (not shown). Cylindrical plug 302 is shown inserted into shaft portion 310. Cylindrical plug 302 includes a first longitudinal bore hole 330 that starts at a first end (e.g., inlet) 331 and extends partially through cylindrical plug 302. Cylindrical plug 302 includes a second longitudinal bore hole 332 that starts at a second end (e.g., outlet) 332 and extends partially through cylindrical plug 302. Cylindrical plug 302 also includes a plurality of radial through holes 304 that extend into first longitudinal bore hole 330 and a plurality of radial through holes 306 that extend into second longitudinal bore hole 332. A plurality of longitudinal passages 350 may be formed between shaft portion 310 and cylindrical plug 302. The plurality of longitudinal passages may be formed as internal splines along the inside 385 of shaft portion 310, or alternatively, as external splines along the outside 386 of cylindrical plug 302. Cylindrical plug 302 operates as a fluid flow direction control device directing coolant from inside the cylindrical plug 302 to the outside of the cylindrical plug 302.

Coolant 322 (e.g., oil) may be supplied to slip ring module 202 via a coolant reservoir 320 and a pump 324. Coolant 322 flows through slip ring module 202 as indicated by arrows 390. Coolant 322 comes into direct contact with first slip ring 204 and second slip ring 206. Shaft portion 310 is coupled with coolant reservoir 320 so that coolant reservoir 320 is in fluidic communication with shaft portion 310.

Referring now to FIG. 4, a cross-section of slip ring module 202 is shown. In this view, passages 350 shown in FIG. 3 are included via splines 402 around the exterior of cylindrical plug 302. Shaft portion 310 captures cylindrical plug 302 and first slip ring 204 is annular in shape.

Referring now to FIG. 5, a cross-section of slip ring module 202 is shown. In this view, passages 350 shown in FIG. 3 are included via splines 402 around the interior of shaft portion 310. Shaft portion 310 captures cylindrical plug 302 and first slip ring 204 is annular in shape.

Thus, the system of FIGS. 1-5 provides for an electric machine, comprising: a rotor including a first slip ring and a second slip ring, the rotor including a shaft; one or more coolant passages arranged to supply coolant to cool the first slip ring and the second slip ring; a first brush in contact with the first slip ring and a second brush in contact with the second slip ring; and a stator. In a first example, the electric machine includes where the one or more coolant passages are arranged such that coolant flowing through the one or more coolant passages directly contacts the first slip ring and the second slip ring. In a second example that may include the first example, the electric machine further comprises a fluid flow distribution device inserted into the shaft. In a third example that may include one or both of the first and second examples, the electric machine includes where the fluid flow distribution device includes the one or more passages. In a fourth example that may include one or more of the first through third examples, the electric machine includes where the shaft includes the one or more passages. In a fifth example that may include one or more of the first through fourth examples, the electric machine includes where the first slip ring and the second slip ring are included in a slip ring module. In a sixth example that may include one or more of the first through fourth examples, the electric machine includes where the slip ring module is fitted to the shaft.

The system of FIGS. 1-5 also provides for a slip ring module, comprising: an annular body; a first slip ring and a second slip ring fixed to the annular body; and a fluid flow distribution device inserted into the annular body. In a first example, the slip ring module further comprises one or more coolant passages within the annular body. In a second example that may include the first example, the slip ring module further comprises one or more coolant passages within the fluid flow distribution device. In a third example that may include one or both of the first and second examples, the slip ring module further comprises a first bore hole and a second bore hole, the first bore hole and the second bore hole oriented in a longitudinal direction of the fluid flow distribution device. In a fourth example that may include one or more of the first through third examples, the slip ring module further comprises a plurality of through holes included in the fluid flow distribution device.

Turning now to FIG. 6, a method for constructing and applying a slip ring module is shown. The method of FIG. 6 may be performed via a human or via machines.

At 602, method 600 couples first and second slip rings to a shaft and the slip rings are electrically coupled to rotor windings. Method 600 proceeds to 604.

At 604, method 600 inserts a cylindrical plug (e.g., 302 of FIG. 3) into the shaft. Method 600 proceeds to 606.

At 606, method 600 couples the shaft to a coolant source, such as a reservoir, and a pump. Method 600 proceeds to 608.

At 608, method 600 activates the pump in response to the electric machine (e.g., propulsion source) is activated. Further, method deactivates the pump in response to the electric machine being deactivated. Method 600 proceeds to 610.

At 610, method 600 supplies coolant to be in direct contact with the interior sides of the slip rings. Method 600 proceeds to exit.

Thus, method 600 provides for construction of a slip ring module and operating the slip ring module. The slip ring module enables electric power to be transferred from stationary elements (e.g., carbon brushes) to a rotating rotor via the slip rings. Coolant flows to the inside of the slip rings to draw heat from the slip rings and the carbon brushes, thereby reducing heat where the rotating elements (slip rings) interface with the stationary elements (carbon brushes).

The method of FIG. 6 provides for a method for cooling slip rings of an electric machine, comprising: inserting a flow distribution device into a rotor shaft of the electric machine; and flowing a coolant past or through the flow distribution device to a first slip ring and a second slip ring. In a first example, the method includes where the coolant flows in direct contact with the first slip ring and the second slip ring. In a second example that may include the first example, the method includes installing a slip ring module to the rotor shaft, where the slip ring module includes the first slip ring and the second slip ring. In a third example that may include one or both of the first and second examples, the method includes where the flow distribution device includes a first longitudinal bore hole and a second longitudinal bore hole. In a fourth example that may include one or more of the first through third examples, the method includes where the flow distribution device includes a plurality of through holes extending into the first longitudinal bore hole, and where the flow distribution device includes a plurality of through holes extending into the second longitudinal bore hole. In a fifth example that may include one or more of the first through fourth examples, the method includes where flowing coolant past or through the flow distribution device includes pumping the coolant. In a sixth example that may include one or more of the first through fifth examples, the method further comprises adjusting a flow rate of the coolant in response to a rotational speed of the electric machine. In a seventh example that may include one or more of the first through sixth examples, the method further comprises flowing the coolant through the rotor shaft.

While various embodiments have been described above, it may be understood that they have been presented by way of example, and not limitation nor restriction. It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The technology may be used as a stand-alone, or used in combination with other power transmission systems not limited to machinery and propulsion systems for tandem axles, electric tag axles, P4 axles, HEVs, BEVs, agriculture, marine, motorcycle, recreational vehicles and on and off highway vehicles, as an example. The subject matter of the present disclosure includes all novel and non-obvious combinations and sub-combinations of the various systems and configurations, and other features, functions, and/or properties disclosed herein. It will be apparent to persons skilled in the relevant arts that the disclosed subject matter may be embodied in other specific forms without departing from the spirit of the subject matter.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

As used herein, the term “approximately” is construed to mean plus or minus five percent of the range, unless otherwise specified.

1. An electric machine, comprising:
a rotor including a first slip ring and a second slip ring, the rotor including a shaft;
one or more coolant passages arranged to supply coolant to cool the first slip ring and the second slip ring;
a first brush in contact with the first slip ring and a second brush in contact with the second slip ring; and
a stator.

2. The electric machine of claim 1, where the one or more coolant passages are arranged such that coolant flowing through the one or more coolant passages directly contacts the first slip ring and the second slip ring.

3. The electric machine of claim 2, further comprising a fluid flow distribution device inserted into the shaft.

4. The electric machine of claim 3, where the fluid flow distribution device includes the one or more coolant passages.

5. The electric machine of claim 3, where the shaft includes the one or more coolant passages.

6. The electric machine of claim 1, where the first slip ring and the second slip ring are included in a slip ring module.

7. The electric machine of claim 6, where the slip ring module is fitted to the shaft.

8. A method for cooling slip rings of an electric machine, comprising:
inserting a flow distribution device into a rotor shaft of the electric machine; and
flowing a coolant past or through the flow distribution device to a first slip ring and a second slip ring.

9. The method of claim 8, where the coolant flows in direct contact with the first slip ring and the second slip ring.

10. The method of claim 8, installing a slip ring module to the rotor shaft, where the slip ring module includes the first slip ring and the second slip ring.

11. The method of claim 8, where the flow distribution device includes a first longitudinal bore hole and a second longitudinal bore hole.

12. The method of claim 11, where the flow distribution device includes a first plurality of through holes extending into the first longitudinal bore hole, and where the flow distribution device includes a second plurality of through holes extending into the second longitudinal bore hole.

13. The method of claim 8, where flowing coolant past or through the flow distribution device includes pumping the coolant.

14. The method of claim 8, further comprising adjusting a flow rate of the coolant in response to a rotational speed of the electric machine.

15. The method of claim 14, further comprising flowing the coolant through the rotor shaft.

16. A slip ring module, comprising:
an annular body;
a first slip ring and a second slip ring fixed to the annular body; and
a fluid flow distribution device inserted into the annular body.

17. The slip ring module of claim 16, further comprising one or more coolant passages within the annular body.

18. The slip ring module of claim 16, further comprising one or more coolant passages within the fluid flow distribution device.

19. The slip ring module of claim 16, further comprising a first bore hole and a second bore hole, the first bore hole and the second bore hole oriented in a longitudinal direction of the fluid flow distribution device.

20. The slip ring module of claim 19, further comprising a plurality of through holes included in the fluid flow distribution device.
